(19) United States
(12) Patent Application Publication
(10) Pub. No.: US 2026/0273959 A1
(43) Pub. Date: Sep. 17, 2026

(54) TAPE PRINTING APPARATUS AND DISPLAY METHOD

(71) Applicant: SEIKO EPSON CORPORATION, Tokyo (JP)

(72) Inventor: Ryota OSAKA, Matsumoto-shi (JP)

(73) Assignee: SEIKO EPSON CORPORATION, Tokyo (JP)

(21) Appl. No.: 19/565,750

(22) Filed: Mar. 13, 2026

(30) Foreign Application Priority Data
Mar. 13, 2025 (JP) 2025-040053

(51) Int. Cl. B41J 3/46; B41J 3/407; B41J 11/66; B41J 29/16; B41J 29/20

(52) U.S. Cl. CPC B41J 3/46; B41J 3/4075; B41J 11/66; B41J 29/16; B41J 29/20

(57) ABSTRACT

A tape printing apparatus including a display unit and a storage unit, the tape printing apparatus including a trimming unit that performs a trimming operation for trimming a corner of a tape-shaped printing medium, a chip tray that is detachably provided in the tape printing apparatus and stores chips generated by trimming the corner, and a controller, in which the controller counts a number of times of the trimming operation performed by the trimming unit, stores, in the storage unit, a cumulative value of the number of times, and displays, when the cumulative value reaches a predetermined threshold, an indicator on the display unit.

The present application is based on, and claims priority from JP Application Serial Number 2025-040053, filed Mar. 13, 2025, the disclosure of which is hereby incorporated by reference herein in its entirety.

### BACKGROUND

### 1. Technical Field

The present disclosure relates to a tape printing apparatus and a display method.

### 2. Related Art

JP-A-2002-137495 discloses a tape printing apparatus with a tape shaping and cutting mechanism for trimming corners of a printing tape. In this tape printing apparatus, chips generated by trimming accumulate in a chip tray detachably provided in the tape printing apparatus.

The tape printing apparatus in the related art has no unit for confirming the amount of chips accumulated in the chip tray. Therefore, when the available capacity of the chip tray is reduced, a cutting failure may occur due to chip clogging.

### SUMMARY

According to a first aspect of the present disclosure, there is provided a tape printing apparatus including a display unit and a storage unit. The tape printing apparatus includes a trimming unit that performs a trimming operation for trimming a corner of a tape-shaped printing medium, a chip tray that is detachably provided in the tape printing apparatus and stores chips generated by trimming the corner, and a controller. The controller counts a number of times of the trimming operation performed by the trimming unit, stores, in the storage unit, a cumulative value of the number of times, and displays, when the cumulative value reaches a predetermined threshold, an indicator on the display unit.

According to a second aspect of the present disclosure, there is provided a display method executed in a tape printing apparatus including a display unit and a storage unit. The display method includes counting a number of times of a trimming operation performed by a trimming unit for trimming a corner of a tape-shaped printing medium, storing, in the storage unit, a cumulative value of the number of times, and displaying, when the cumulative value reaches a predetermined threshold, an indicator on the display unit.

### BRIEF DESCRIPTION OF THE DRAWINGS

FIG. 1 is a perspective view illustrating a tape printing apparatus according to a first embodiment.

FIG. 2 is an explanatory view of a trimming unit provided in the tape printing apparatus.

FIG. 3 is an explanatory view of a chip tray.

FIG. 4 is a block diagram of the tape printing apparatus.

FIG. 5 is a flowchart of trimming processing.

FIG. 6 is a view illustrating an example in which indicators are displayed on a display unit.

FIG. 7 is a flowchart of reset processing.

### DESCRIPTION OF EMBODIMENTS

### A. First Embodiment

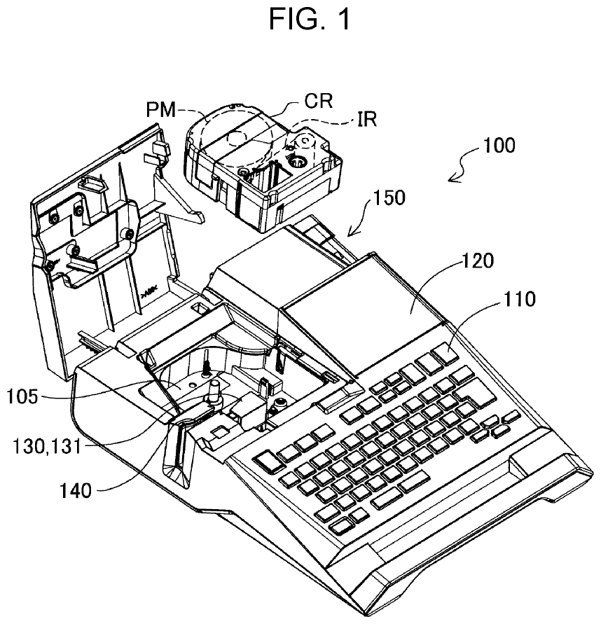

FIG. 1 is a perspective view illustrating a tape printing apparatus 100 according to a first embodiment. The tape printing apparatus 100 performs printing on a tape-shaped printing medium PM. The printing medium PM is mounted in a cartridge mounting portion 105 of the tape printing apparatus 100 in a state of being stored in a cartridge CR. The cartridge CR is replaceable. An ink ribbon IR is stored in the cartridge CR together with the printing medium PM.

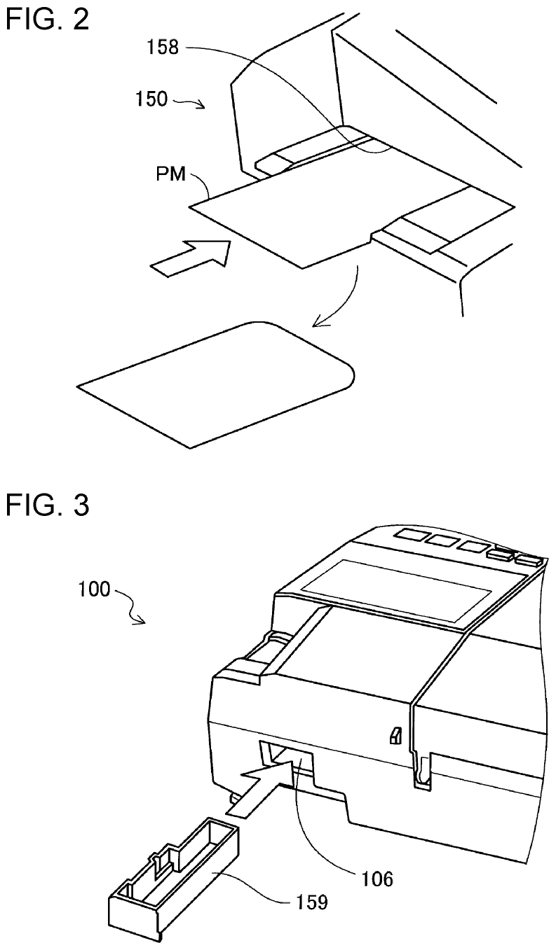

FIG. 2 is an explanatory view of a trimming unit 150 provided in the tape printing apparatus 100. The tape printing apparatus 100 includes the trimming unit 150 that performs a trimming operation for trimming corners of the tape-shaped printing medium PM. An insertion port 158 into which the printing medium PM is inserted is provided on a side surface of a housing of the tape printing apparatus 100. When the printing medium PM is inserted into the insertion port 158, a cutter disposed inside the tape printing apparatus 100 is driven and cuts two corners of the printing medium PM into round corners.

FIG. 3 is an explanatory view of a chip tray 159. The chip tray 159 is detachably provided in the tape printing apparatus 100. The chip tray 159 stores chips generated when the corners of the printing medium PM are trimmed. In the present embodiment, the chip tray 159 is inserted into a slot 106 formed in the rear surface of the tape printing apparatus 100.

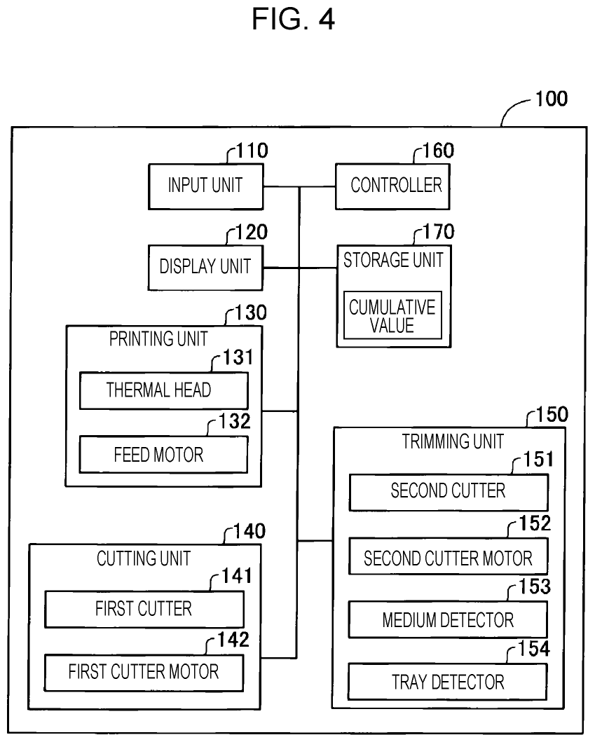

FIG. 4 is a block diagram of the tape printing apparatus 100. The tape printing apparatus 100 includes an input unit 110, a display unit 120, a printing unit 130, a cutting unit 140, the trimming unit 150, a controller 160, and a storage unit 170.

The input unit 110 is a keyboard and receives an input operation of print contents and various setting operations from the user.

The display unit 120 is a liquid crystal display and displays characters and images.

The printing unit 130 performs printing on the printing medium PM. The printing unit 130 includes a thermal head 131 and a feed motor 132. The thermal head 131 includes a plurality of heating elements (not illustrated). The thermal head 131 thermally transfers ink of the ink ribbon IR onto a surface of the printing medium PM to form a plurality of dots representing characters and figures. The feed motor 132 feeds the printing medium PM and the ink ribbon IR by being rotationally driven.

The cutting unit 140 cuts the printing medium PM on which printing has been performed by the printing unit 130. The cutting unit 140 includes a first cutter 141 that cuts the printing medium PM and a first cutter motor 142 that drives the first cutter 141. The printing medium PM cut by the first cutter 141 is discharged from a tape discharge port of the tape printing apparatus 100. The cut printing medium PM is used as a label.

The trimming unit 150 performs a trimming operation for trimming the corners of the tape-shaped printing medium PM. The trimming unit 150 includes a second cutter 151 that cuts the corners of the printing medium PM, a second cutter motor 152 that drives the second cutter 151, a medium detector 153 that detects insertion of the printing medium PM into the insertion port 158, and a tray detector 154 that detects an attachment state of the chip tray 159 to the slot 106.

The medium detector 153 in the present embodiment is an optical sensor. The medium detector 153 includes a light emitter and a light receiver. The medium detector 153 detects insertion of the printing medium PM into the insertion port 158 by detecting, using the light receiver, that the printing medium PM inserted into the insertion port 158 blocks the light emitted from the light emitter. When the medium detector 153 detects the insertion of the printing medium PM into the insertion port 158, the second cutter motor 152 operates and drives the second cutter 151. The chips of the corners of the printing medium PM cut by the second cutter 151 fall on the chip tray 159 detachably attached to the tape printing apparatus 100 and accumulate in the chip tray 159. The chip tray 159 is disposed below the first cutter 141 in the tape printing apparatus 100.

The tray detector 154 in the present embodiment is an optical sensor. The tray detector 154 includes a light emitter and a light receiver. The tray detector 154 detects removal of the chip tray 159 from the slot 106 by detecting that the light receiver receives the light from the light emitter, which has been blocked by the chip tray 159. Further, the tray detector 154 detects attachment of the chip tray 159 to the slot 106 by detecting, using the light receiver, that the chip tray 159 inserted into the slot 106 blocks the light emitted from the light emitter.

The controller 160 includes a processor that controls the tape printing apparatus 100. The controller 160 implements various functions of the tape printing apparatus 100 by executing programs stored in the storage unit 170.

The controller 160 counts the number of times of the trimming operation performed by the trimming unit 150 and stores the cumulative value of the number of times of the trimming operation in the storage unit 170 in a nonvolatile manner. When the cumulative value stored in the storage unit 170 reaches a predetermined threshold, the controller 160 displays a predetermined indicator on the display unit 120. Details of the processing performed by the controller 160 will be described below.

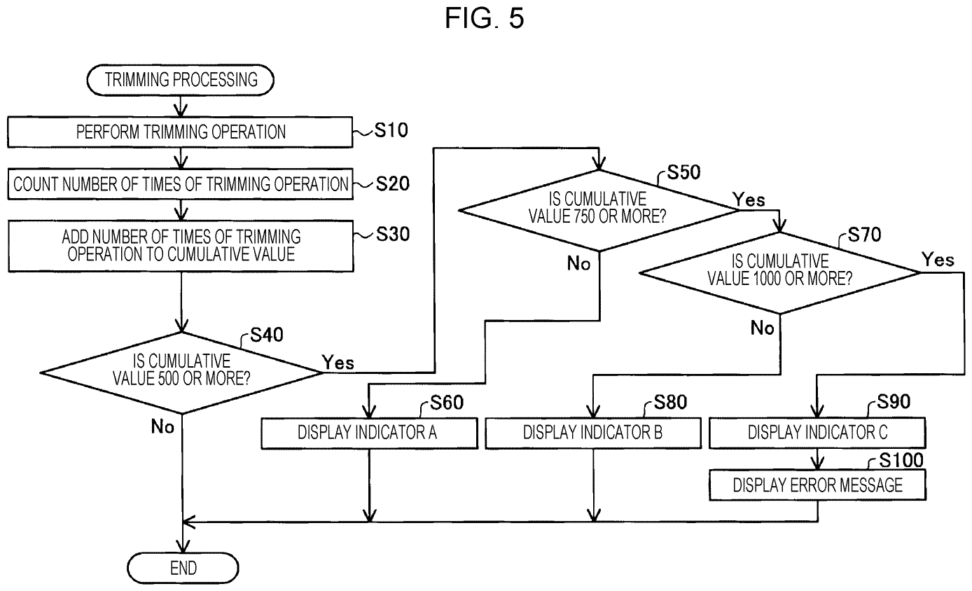

FIG. 5 is a flowchart of the trimming processing. The processing is executed by the controller 160 when the medium detector 153 detects the insertion of the printing medium PM into the insertion port 158.

In step S10, the controller 160 controls the trimming unit 150 to perform the trimming operation. In the trimming operation, the second cutter motor 152 is controlled to drive the second cutter 151 to cut the corners of the printing medium PM. The trimming operation is performed until the medium detector 153 can no longer detect the printing medium PM or until a predetermined time elapses, whichever is earlier. The predetermined time is, for example, 5 seconds. In the trimming operation, the second cutter 151 is repeatedly driven by the second cutter motor 152 until the above-described end timing.

In step S20, the controller 160 counts the number of times of the trimming operation. The number of times of the trimming operation performed in step S10 described above is one. Even in a case where the second cutter 151 is driven a plurality of times from the start of the trimming operation until the above-described end timing elapses, the number of times of the trimming operation performed in step S10 is one.

In step S30, the controller 160 adds the number of times of the trimming operation counted in step S20 to the cumulative value stored in the storage unit 170. That is, the controller 160 adds “1” to the cumulative value stored in the storage unit 170.

In step S40, the controller 160 refers to the cumulative value stored in the storage unit 170 and determines whether the cumulative value is equal to or larger than a first threshold. In the present embodiment, the first threshold is, for example, 500. When the cumulative value has not reached the first threshold, that is, when the cumulative value is less than the first threshold, the controller 160 ends the trimming processing.

When the cumulative value reaches the first threshold and becomes equal to or larger than 500, the controller 160 determines whether the cumulative value becomes equal to or larger than a second threshold, which is larger than the first threshold. In the present embodiment, two second thresholds are defined. The two second thresholds are, for example, 750 and 1000 in the present embodiment. In step S50, the controller 160 determines whether the cumulative value is equal to or larger than the smaller one of the second thresholds. When the cumulative value has not reached the smaller second threshold, that is, when the cumulative value is equal to or larger than 500 and less than 750, the controller 160 displays an indicator A on the display unit 120 in step S60.

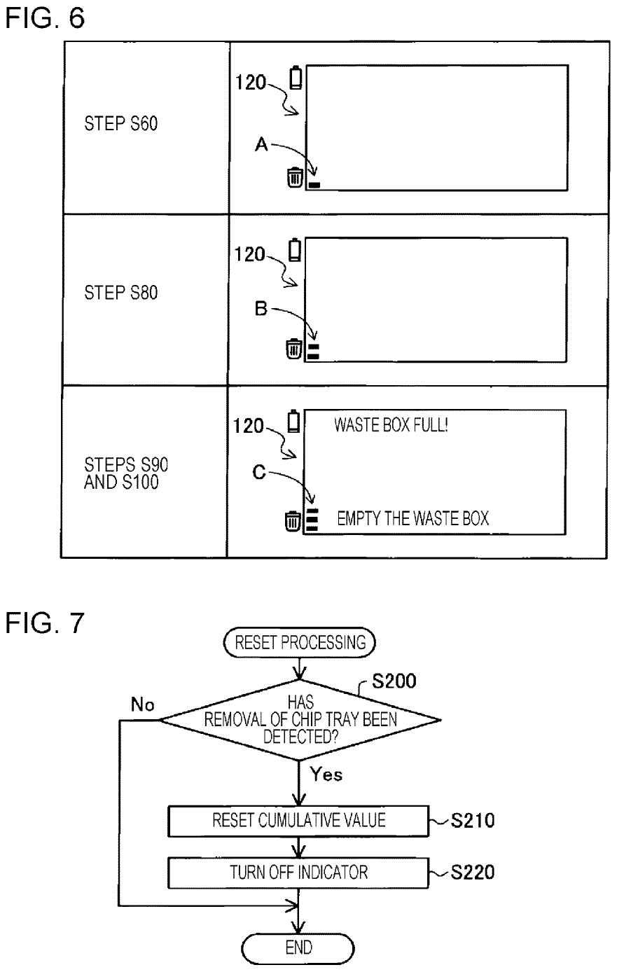

FIG. 6 is a view illustrating an example in which indicators are displayed on the display unit 120. In step S60, the controller 160 displays the indicator A indicating one graduation as the indicator on the display unit 120 and ends the trimming processing. The indicator A is continuously displayed on the display unit 120 during the operation of the tape printing apparatus 100 until an indicator B or an indicator C to be described later is displayed or until the cumulative value is reset by reset processing to be described later. The indicator A corresponds to a first indicator corresponding to the first threshold.

When it is determined in step S50 that the cumulative value has reached the smaller second threshold, that is, when the cumulative value is equal to or larger than 750, the controller 160 determines in step S70 whether the cumulative value is equal to or larger than the largest one of the second thresholds. When the cumulative value has not reached the largest second threshold, that is, when the cumulative value is equal to or larger than 750 and less than 1000, the controller 160 displays the indicator B indicating two graduations as the indicator on the display unit 120 in step S80 as illustrated in FIG. 6 and ends the trimming processing. The indicator B is continuously displayed on the display unit 120 during the operation of the tape printing apparatus 100 until the indicator C to be described later is displayed or until the cumulative value is reset by the reset processing to be described later.

When it is determined in step S70 that the cumulative value has reached the largest second threshold, that is, when the cumulative value is equal to or larger than 1000, the controller 160 displays the indicator C indicating three graduations as the indicator on the display unit 120 in step S90 and further displays an error message on the display unit 120 in step S100, as illustrated in FIG. 6. As illustrated in FIG. 6, in the present embodiment, the controller 160 displays a message “EMPTY THE WASTE BOX” as the error message on the display unit 120. After displaying the error message on the display unit 120, the controller 160 ends the trimming processing. The indicator C is continuously displayed on the display unit 120 during the operation of the tape printing apparatus 100 until the cumulative value is reset by the reset processing to be described later. The error message is turned off after being displayed on the display unit 120 for a certain period of time. The indicator B and the indicator C correspond to a second indicator corresponding to the second threshold.

In the trimming processing described above, the first threshold and the second thresholds are determined in advance according to the capacity of the chip tray 159 and the volume of the chips cut from the printing medium PM by the trimming operation. For example, the largest second threshold of the second thresholds is the number of times of the trimming operation corresponding to the number of chips with which the chip tray 159 is completely filled or nearly filled. The first threshold is, for example, a half value of the largest second threshold. The smaller second threshold is an intermediate value between the first threshold and the largest second threshold. In the present embodiment, the number of the second thresholds is two, but may be three or more.

The indicator displayed on the display unit 120 in the trimming processing described above is continuously displayed on the display unit 120 even when the tape printing apparatus 100 is restarted. For example, the controller 160 reads the cumulative value stored in the storage unit 170 in a nonvolatile manner at the time of activation of the tape printing apparatus 100 and executes processing corresponding to steps S40 to S90 in FIG. 5, thereby displaying an indicator corresponding to the cumulative value on the display unit 120.

FIG. 7 is a flowchart of the reset processing. The reset processing is repeatedly executed in a period in which the trimming processing described above is not executed during the operation of the tape printing apparatus 100.

In step S200, the controller 160 uses the tray detector 154 to detect whether the chip tray 159 has been removed from the slot 106. When the removal of the chip tray 159 from the slot 106 is detected, in step S210, the controller 160 resets the cumulative value stored in the storage unit 170 to “0”. In step S220, when an indicator is displayed on the display unit 120, the controller 160 turns off the indicator. When the removal of the chip tray 159 from the slot 106 is not detected, the processing of steps S210 and S220 is skipped. In step S200, instead of detecting the removal of the chip tray 159 from the slot 106, the controller 160 may reset the cumulative value in step S210 when detecting attachment of the chip tray 159 to the slot 106.

The tape printing apparatus 100 of the first embodiment described above counts the number of times of the trimming operation performed by the trimming unit 150 and when the cumulative value of the number of times of the trimming operation reaches the predetermined threshold, displays an indicator on the display unit 120. Therefore, the user can easily confirm the state of the chips accumulated in the chip tray 159 without removing the chip tray 159 by referring to the indicator displayed on the display unit 120. Therefore, the chips can be easily removed before the chip tray 159 becomes full, and the occurrence of poor trimming due to chip clogging can be suppressed.

Further, in the present embodiment, the threshold to be compared with the cumulative value of the trimming operation includes the first threshold and at least one second threshold larger than the first threshold. When the cumulative value reaches the first threshold, the controller 160 displays, as the indicator, the first indicator corresponding to the first threshold on the display unit 120, and when the cumulative value reaches the second threshold, the controller 160 displays, as the indicator, the second indicator corresponding to the second threshold on the display unit 120. As described above, in the present embodiment, since the indicator is displayed on the display unit 120 in a stepwise manner, the user can easily confirm the state of the chips accumulated in the chip tray 159.

In addition, in the present embodiment, when the cumulative value reaches the largest second threshold among the thresholds, the controller 160 displays an error message on the display unit 120 in addition to the indicator. Therefore, the user can easily confirm that the chip tray 159 is full by referring to the error message.

Further, in the present embodiment, when the tray detector 154 detects removal of the chip tray 159, the cumulative value stored in the storage unit 170 is reset. Therefore, when the chip tray 159 is removed and the chips are removed, the cumulative value of the number of times of the trimming operation can be automatically reset.

### B. Other Embodiments

B1. In the above-described embodiment, the medium detector 153 and the tray detector 154 are optical sensors. On the other hand, the medium detector 153 and the tray detector 154 may be configured by a mechanical push switch or the like that turns on or off by coming into contact with the printing medium PM or the chip tray 159.

B2. In the above-described embodiment, the controller 160 executes the reset processing illustrated in FIG. 7, so that the cumulative value stored in the storage unit 170 is automatically reset when attachment or removal of the chip tray 159 is detected. On the other hand, the controller 160 does not have to execute the reset processing illustrated in FIG. 7. In this case, the controller 160 resets the cumulative value when detecting a predetermined operation by the user through the input unit 110 or an operation of a reset button provided in the tape printing apparatus 100. In this way, in cases such as when the user does not remove the chips after the chip tray 159 is removed, or when the user removes the chips in a state where the amount of the chips is small, the user can manually perform the reset.

B3. The first and second thresholds in the above-described embodiment may be appropriately changed by the user. It is assumed that the storage position of the tape printing apparatus 100 after use varies depending on the user. For example, the tape printing apparatus 100 may be stored in a standing position, may be moved in a bag or the like, or may be always placed flat on a desk. Such a storage position can result in chip biasing inside the chip tray 159, which can result in chip clogging even when the tray is not filled with chips. Therefore, if the first and second thresholds can be appropriately changed, the display timing of the indicator or the error message can be changed according to the use environment of the user of the tape printing apparatus 100.

In addition, the first and second thresholds do not have to be set to numerical values by the user, and for example, the user may select a mode such as a leaning mode or a flat placement mode and apply a threshold set in advance for the mode.

B4. In the above-described embodiment, the second cutter 151 cuts two corners of the printing medium PM inserted into the insertion port 158. However, when the width of the printing medium PM is smaller than the width of the insertion port 158, only one corner of the printing medium PM may be cut. Therefore, the controller 160 may change the method of counting the number of times of the trimming operation according to the width of the printing medium PM. For example, when a sensor detects insertion of the printing medium PM having a width narrower than that of the insertion port 158, the controller 160 does not count the number of times of the trimming operation as one but counts the number of times as 0.5. In this way, the state of the chip tray 159 can be displayed on the display unit 120 according to the width of the printing medium PM. Instead of detecting the insertion of the printing medium PM having a width narrower than that of the insertion port 158 by the sensor, the controller 160 may determine the width of the printing medium PM based on the setting of the printing medium PM by the user.

B5. In the above-described embodiment, the first indicator and the second indicator are displayed on the display unit 120 on which images, characters, error messages, and the like are displayed. On the other hand, the first indicator and the second indicator may be displayed on a dedicated display unit for displaying the accumulation state of the chips. As such a display unit, for example, a light emitting diode can be used.

B6. In the above-described embodiment, the first indicator and the second indicator have a graduation form. On the other hand, the first indicator and the second indicator are not limited to graduations, and may be represented by, for example, a difference in color or a difference in numerical value.

B7. In the above-described embodiment, the threshold to be compared with the cumulative value of the number of times of the trimming operation includes the first and second thresholds. On the other hand, only one threshold may be used.

B8. In the above-described embodiment, in step S100 of the trimming processing illustrated in FIG. 5, the error message is displayed on the display unit 120. On the other hand, the display of the error message in step S100 may be omitted.

### C. Other Aspects

The present disclosure is not limited to the above-described embodiments, and can be realized in various configurations within the scope not departing from the concept of the present disclosure. For example, technical features in the embodiments corresponding to technical features in each aspect to be described below can be replaced or combined as appropriate to solve some or all of the problems described above, or to achieve some or all of the effects described above. In addition, unless the technical features are described as essential in the present specification, the technical features can be deleted as appropriate.

(1) According to a first aspect of the present disclosure, there is provided a tape printing apparatus including a display unit and a storage unit. The tape printing apparatus includes a trimming unit that performs a trimming operation for trimming a corner of a tape-shaped printing medium, a chip tray that is detachably provided in the tape printing apparatus and stores chips generated by trimming the corner, and a controller. The controller counts a number of times of the trimming operation performed by the trimming unit, stores, in the storage unit, a cumulative value of the number of times, and displays, when the cumulative value reaches a predetermined threshold, an indicator on the display unit.

According to such an aspect, the state of the chips accumulated in the chip tray can be confirmed by referring to the indicator displayed on the display unit. Therefore, the chips can be easily removed before the chip tray becomes full, and the occurrence of poor trimming due to chip clogging can be suppressed.

(2) In the above aspect, the threshold may include a first threshold and at least one second threshold larger than the first threshold, when the cumulative value reaches the first threshold, the controller may display, as the indicator, a first indicator corresponding to the first threshold on the display unit, and when the cumulative value reaches the second threshold, the controller may display, as the indicator, a second indicator corresponding to the second threshold on the display unit. With such a configuration, since the indicator is displayed on the display unit in a stepwise manner, the state of the chips accumulated in the chip tray can be easily confirmed.

(3) In the above aspect, when the cumulative value reaches the second threshold that is largest of the thresholds, the controller may display an error message on the display unit in addition to the indicator. With such a configuration, the chip tray being full can be easily confirmed by referring to the error message.

(4) In the above aspect, the tape printing apparatus may further include a tray detector that detects removal or attachment of the chip tray, and when the tray detector detects removal or attachment of the chip tray, the controller may reset the cumulative value stored in the storage unit. With such a configuration, when the chip tray is removed and the chips are removed, the cumulative value of the number of times of the trimming operation can be automatically reset.

(5) According to a second aspect of the present disclosure, there is provided a display method executed in a tape printing apparatus including a display unit and a storage unit. The display method includes counting a number of times of a trimming operation performed by a trimming unit for trimming a corner of a tape-shaped printing medium, storing, in the storage unit, a cumulative value of the number of times, and displaying, when the cumulative value reaches a predetermined threshold, an indicator on the display unit.

The present disclosure can be realized in various forms such as a computer program and a non-transitory tangible recording medium in which a computer program is recorded so as to be readable by a computer, for example, in addition to the form as the tape printing apparatus and the display method described above.

What is claimed is:

1. A tape printing apparatus including a display unit and a storage unit, the tape printing apparatus comprising:
a trimming unit that performs a trimming operation for trimming a corner of a tape-shaped printing medium;
a chip tray that is detachably provided in the tape printing apparatus and stores chips generated by trimming the corner; and
a controller, wherein
the controller
counts a number of times of the trimming operation performed by the trimming unit,
stores, in the storage unit, a cumulative value of the number of times, and
displays, when the cumulative value reaches a predetermined threshold, an indicator on the display unit.

2. The tape printing apparatus according to claim 1, wherein
the threshold includes a first threshold and at least one second threshold larger than the first threshold,
when the cumulative value reaches the first threshold, the controller displays, as the indicator, a first indicator corresponding to the first threshold on the display unit, and
when the cumulative value reaches the second threshold, the controller displays, as the indicator, a second indicator corresponding to the second threshold on the display unit.

3. The tape printing apparatus according to claim 2, wherein
when the cumulative value reaches the second threshold that is largest of the thresholds, the controller displays an error message on the display unit in addition to the indicator.

4. The tape printing apparatus according to claim 1, further comprising:
a tray detector that detects removal or attachment of the chip tray, wherein
when the tray detector detects removal or attachment of the chip tray, the controller resets the cumulative value stored in the storage unit.

5. A display method executed in a tape printing apparatus including a display unit and a storage unit, the method comprising:
counting a number of times of a trimming operation performed by a trimming unit for trimming a corner of a tape-shaped printing medium;
storing, in the storage unit, a cumulative value of the number of times; and
displaying, when the cumulative value reaches a predetermined threshold, an indicator on the display unit.
